(19) United States
(12) Patent Application Publication
(10) Pub. No.: US 2025/0295999 A1
(43) Pub. Date: Sep. 25, 2025

(54) RECORDING MEDIUM AND INFORMATION PROCESSING DEVICE THAT EXECUTE GAMING BASED ON POSITION INFORMATION IN REAL WORLD

(71) Applicant: SEGA CORPORATION, Tokyo (JP)

(72) Inventors: Kazuki Yoshikawa, Tokyo (JP); Toshiyuki Mukaiyama, Tokyo (JP)

(73) Assignee: SEGA CORPORATION, Tokyo (JP)

(21) Appl. No.: 19/209,157

(22) Filed: May 15, 2025

Related U.S. Application Data
(63) Continuation of application No. PCT/JP2023/037981, filed on Oct. 20, 2023.

(30) Foreign Application Priority Data
Nov. 17, 2022 (JP) 2022-184068

(51) Int. Cl. A63F 13/65; A63F 13/216; A63F 13/44

(52) U.S. Cl. CPC A63F 13/65; A63F 13/216; A63F 13/44

(57) ABSTRACT

A non-transitory computer readable recording medium stores instructions that execute gaming based on position information of players in a real world, the instructions causing a computer to execute: acquiring a current position of each of the players in the real world; and executing a match game with an enemy object in an appearance time of the enemy object in which any of the players can commonly match the enemy object, on condition that the current position has reached a match allowable range with the enemy object. The executing the match game includes expanding the match allowable range upon determining that a number of times of execution of the match game is less than a predetermined number of times at a predetermined time point.

### BACKGROUND

### Technical Field

The present invention relates to a recording medium storing instructions and information processing device that execute gaming based on position information of players in a real world.

### Description of Related Art

Conventionally, a position information game for moving a player object (e.g. a player character) in a virtual world is detected based on the position information in the real world of the player.

In this regard, Patent Document 1 discloses a technique that can match each player with a common enemy object (raid boss).

### Non-Patent Documents

Patent Document 1: U.S. Pat. No. 6,090,495

### Technological Problem to be Solved by the Invention

In such a position information game, a player who plays in an area where the number of players (play population) is large can easily conquer a common enemy object (raid boss). On the other hand, a player who plays in an area with a small number of players would not easily conquer a common enemy object. Thus, conventional gaming systems do not provide any functionality to level the playing field for players who play in the area with the small number.

### SUMMARY

One or more embodiments of the present invention provide a recording medium storing instructions and information processing device that execute gaming based on position information of players in a real world, and adjust a match allowance time and/or an appearance time of an enemy object which players can commonly match such that all the players being in the real world can match the enemy object at an appropriate frequency in the virtual world.

According to a first aspect of the present invention, a non-transitory computer readable recording medium stores instructions that execute gaming based on position information of players in a real world, and the instructions cause a computer to execute: acquiring a current position of each of the players in the real world; and executing a match game with an enemy object in an appearance time of the enemy object in which any of the players can commonly match the enemy object, on condition that the current position reached an allowable range to engage in a match with the enemy object, wherein the executing the match game includes expanding the match allowable range upon determining that a number of times of execution of the match game is less than a predetermined number of times at a predetermined time point.

Furthermore, in a second aspect of the present invention, the predetermined time point is a time point at which a unit time has elapsed, and the executing the match game includes expanding the match allowable range upon determining that the number of times per the unit time is less than the predetermined number of times each time the unit time elapses.

Furthermore, in a third aspect of the present invention, the predetermined time point is a time point at which the appearance time is less than a fixed time.

Furthermore, in a fourth aspect of the present invention, the executing the match game includes extending the appearance time when the match allowable range is expanded.

Furthermore, according to a fifth aspect of the present invention, a non-transitory computer readable recording medium stores instructions that execute gaming based on position information of players in a real world, and the instructions cause the computer to execute: acquiring a current position of each of the players; and executing a match game with an enemy object in an appearance time of the enemy object in which any of the players can commonly match the enemy object, on condition that the current position has reached a match allowable range with the enemy object, wherein the executing the match game includes extending the appearance time upon determining that a number of times of execution of the match game is less than a predetermined number of times at a predetermined time point.

Furthermore, in a sixth aspect of the present invention, the predetermined time point is a time point at which a unit time has elapsed, and the executing the match game includes extending the appearance time upon determining that a number of times per the unit time is less than the predetermined number of times each time the unit time elapses.

Furthermore, in a seventh aspect of the present invention, the predetermined time point is a time point at which the appearance time becomes less than a fixed time.

According to one or more embodiments of the present invention, it becomes possible to execute gaming based on the position information of the players in the real world, and adjust the match allowance time and/or the appearance time of the enemy object which the players can commonly match such that all the players being in the real world can match the enemy object at an appropriate frequency in the virtual world.

### BRIEF DESCRIPTION OF THE DRAWINGS

FIG. 1 is a block diagram illustrating an example of an overall configuration of a game system according to a first embodiment.

FIG. 2 is a diagram schematically showing an example of a hardware configuration of the server device shown in FIG. 1.

FIG. 3 is a diagram illustrating an example of a hardware configuration of a smartphone as a terminal device shown in FIG. 1.

FIG. 4 is a block diagram illustrating an example of a functional configuration of a server device.

FIG. 5 is a flowchart illustrating an example of a flow of a process in which a player performs a match game with a raid boss monster in a game system according to the first embodiment.

FIG. 6 is a diagram illustrating an example of a game screen according to the first embodiment.

FIG. 7 is a flowchart illustrating an example of a flow of processing for expanding a match allowable range and extending an appearance time in a game system according to the first embodiment.

FIG. 8 is a flowchart illustrating an example of a flow of processing for extending the match allowable range and extending the appearance time in the game system according to a second embodiment.

### DETAILED DESCRIPTION OF EMBODIMENTS

Hereinafter, embodiments of the present invention will be described with reference to the accompanying drawings. In order to facilitate understanding of the description, the same components and steps in the drawings are denoted by the same reference numerals to the extent possible, and redundant descriptions thereof will be omitted.

### First Embodiment

First, a first embodiment will be described.

### Overall Configuration

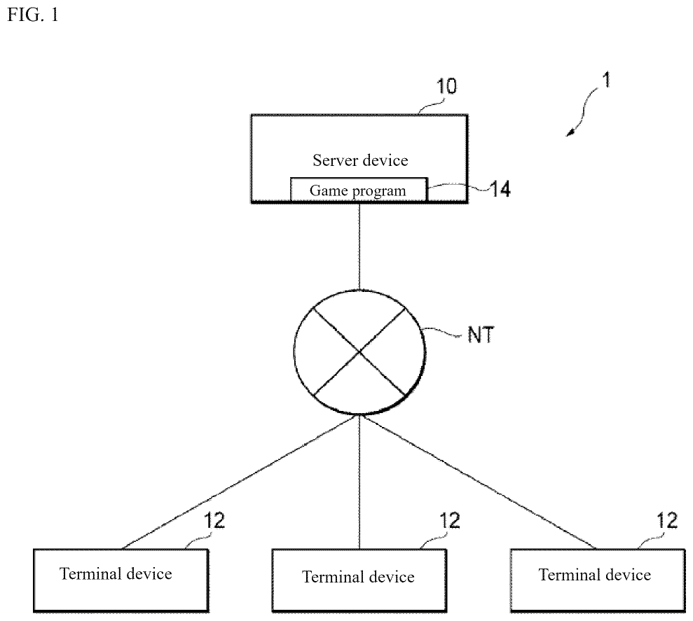

FIG. 1 is a block diagram illustrating an example of the overall configuration of a game system 1 according to the first embodiment.

As shown in FIG. 1, the game system 1 includes a server device 10 and one or a plurality of terminal devices 12. The server device 10 and the terminal device(s) 12 are communicably connected to each other via a communication network NT such as the Internet, a telephone line, or an intranet.

The server device 10 is an information processing device that provides instructions such as a game program 14 themselves or the execution result of the game obtained by executing the instructions to the player of each terminal device 12 via the communication network NT.

Each terminal device 12 is a portable communication terminal device that can be operated by each player and can be carried. Examples of each terminal device 12 include a smartphone, a mobile phone, a tablet, a notebook computer, and the like. Each terminal device 12 is an information processing device that transmits operation information of the player to the server device 10, outputs the execution result of the instructions received from the server device 10, or executes the instructions on the basis of the operation information of the player, thereby providing a game to the player. The instructions may be executed in cooperation with the terminal device 12 and the server device 10.

### Hardware Configuration

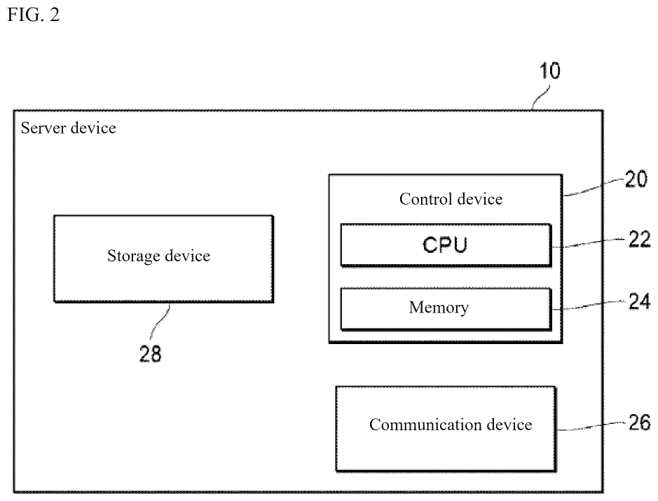

FIG. 2 is a diagram schematically showing an example of a hardware configuration of the server device 10 illustrated in FIG. 1.

As illustrated in FIG. 2, the server device 10 includes a control device (or controller) 20, a communication device 26, and a storage device (or storage) 28. The control device 20 mainly includes a central processing unit (CPU) 22 and a memory 24.

In the control device 20, the CPU 22 functions as various functional units by executing predetermined instructions such as a program stored in the memory 24 or the storage device 28. Details of the functional units will be described later.

The communication device 26 is configured by a communication interface or the like for communicating with an external device. The communication device 26 transmits and receives various types of information to and from the terminal device 12, for example.

The storage device 28 is composed of a hard disk or the like. The storage device 28 stores various instructions, various types of information, and information of the processing results necessary for executing the processing in the control device 20 including the game program 14.

Note that the server device 10 can be realized using an information processing device such as a dedicated or general-purpose server computer. In addition, the server device 10 may be configured from a plurality of information processing devices distributed on the communication network NT, even if the server device 10 is configured from a single information processing device. In addition, FIG. 2 is merely a part of the main hardware configuration of the server device 10, and the server device 10 can include another configuration generally provided to servers.

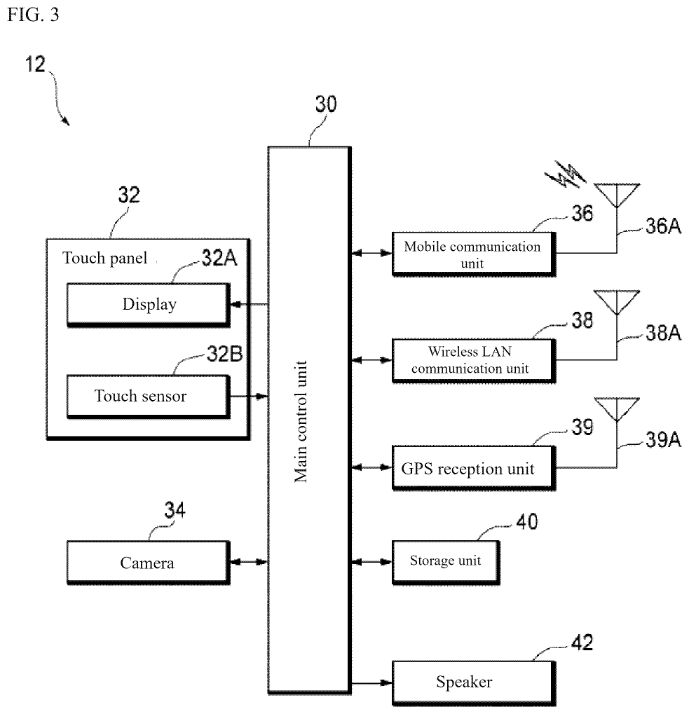

FIG. 3 is a diagram illustrating an example of a hardware configuration of the smartphone as the terminal device 12 illustrated in FIG. 1.

As illustrated in FIG. 3, the terminal device 12 includes a main control unit (or main controller) 30, a touch panel 32, an acceleration sensor 33, an angular velocity sensor 34, a mobile communication unit (or mobile communication interface) 36, a wireless LAN communication unit (wireless LAN communication interface) 38, a GPS receiving unit (or GPS receiver) 39, a storage unit (or storage) 40, and a speaker 42.

The composition of the main control unit 30 includes a CPU, a memory, and the like. The main control unit 30 is connected to the touch panel 32 as a display input device, the acceleration sensor 33, the angular velocity sensor 34, the mobile communication unit 36, the wireless LAN communication unit 38, the GPS reception unit 39, the storage unit 40, and the speaker 42. Further, the main control unit 30 has a function of controlling these connection destinations.

The touch panel 32 is composed of a display 32 A having both functions of a display function and an input function and is responsible for a display function, and is composed of a touch sensor 32 B responsible for an input function. In the first embodiment, the display 32 A can display a game image including an operation input image such as a button image, a cross key image, a joystick image, and the like. The touch sensor 32 B can detect an input position of the player relative to the game image.

The acceleration sensor 33 can measure the acceleration of the terminal device 12, in other words, the acceleration of the player. Specifically, the acceleration sensor 33 can detect the movement and vibration of the player.

The angular velocity sensor 34 can measure the orientation and inclination of the terminal device 12.

The mobile communication unit 36 has a function of connecting with the mobile communication network via the antenna 36 A and communicating with other communication devices connected to the mobile communication network.

The wireless LAN communication unit 38 has a function of communicating with the communication network NT via the antenna 38 A and communicating with other devices such as a server device 10 or the like connected to the communication network NT.

The GPS reception unit 39 has a function of receiving radio waves from the GPS satellite via the antenna 39 A and acquiring position information indicating the current position of the player. This position information is, for example, latitude and longitude.

Various instructions and various data including all or a part of the game program 14 are stored in the storage unit 40.

The speaker 42 has a function of outputting a game sound or the like.

### Game Summary

The game according to the first embodiment is a position information game that reflects the position and movement of the player in the real world on the game content. In this game, for example, by moving the player in the real world, the player object disposed in the game field (virtual world) also moves. The player object is one or a plurality of characters that the player can use in the game. The player instructs the player object by performing an input operation or the like on the touch panel 32. The player object may be a robot, a vehicle, an airplane, a ship, or the like besides a character.

Further, in the game according to the first embodiment, a field mode and an event mode exist.

The field mode is a mode in which the player object moves the game field. In this field mode, the player can instruct the player object to use (attach/detach) of an owned item of equipment and use (consume) owned consumable items or the like. The equipment items include, for example, a weapon, a protective armor, an accessory, and the like. The consumable items include, for example, a tool that recovers hit points of the player object, a tool that recovers a status abnormality (paralysis, confusion, or the like) of the player object, a tool that enhances equipment items, and the like.

In addition, the event mode is a mode in which the player moves the real world, that is, an event that has occurred in response to the player object moving the game field. This event is, for example, a match game with an enemy object. Examples of the enemy object include, for example, a normal monster, a boss monster, a raid boss monster, and the like.

For example, a match game with a normal monster is performed on the condition that a normal monster appears around a player object in a game field. This normal monster appears randomly (randomly) in accordance with each region of the game field. For example, the player can execute a match game with the normal monster by designating (e.g. touching) the normal monster appearing in the game field.

In addition, a match game with a boss monster is executed on the condition that the current position of the player has reached the destination of a quest.

In addition, a match game with a raid boss monster is executed on the condition that the current position of the player has reached the periphery (match allowable range) of the spawn point of the raid boss monster. The match game with this raid boss monster is, for example, a common event in which each player can participate in common, and each player cooperates with each other to conquer the raid boss monster. Specifically, each player plays a match with a common (identical) raid boss monster, and cooperates with each other to gradually reduce the hit points of the raid boss monster to conquer the raid boss monster.

In these match games, the player instructs the player object to, for example, use attacks or skills, defend, use (consume) items, and the like. When the player conquers various monsters, rewards will be granted to the player. Conquer here means to, for example, reduce the hit points of a monster to 0 or less. Rewards include, for example, experience points for growing (leveling up) the player object, currencies (e.g. medal or coin) usable in the game, dropping of items (for example, equipment items, consumable items), and the like. For example, when the ability of the monster is high or the appearance frequency is low, many experience points, currency, and the like are granted as rewards.

In addition, the game according to the first embodiment has a plurality of types of quests and has different nomenclatures (titles). Each quest can be selected by a player on a quest menu screen or the like. The player can clear the quest by conquering the boss monster encountered at the destination (goal point) of the quest. Quests includes normal quests and time-limited quests. With respect to normal quests, players will be able to play the subsequent quests by clearing quests that the player can select (open). In this subsequent quests, for example, a degree of difficulty higher than earlier quests is set, and the ability of the monster or the boss monster is increased. The time-limited quests are quests in a format in which a quest selectable in a time slot or a period is replaced. In these quests, a normal monster appearing in a game field and a boss monster appearing at a destination of a quest are associated with each other.

Further, in the game according to the first embodiment, the spawn point of the raid boss monster and the destination of each quest are set at physical points in the real world. Examples of these physical points include commercial facilities, public facilities, sightseeing locations, and the like. These points are associated with virtual points in the game field, and the virtual points may be an appearance point of a raid boss monster or a boss monster. In addition, for example, the player who is executing the quest can engage in a match with a normal monster appearing in the game field or the raid boss monster on the midway (on the moving path) toward the destination of the quest.

For example, the player can match with the raid boss monster while cooperating with another player by reaching (moving) to the vicinity (match allowable range) of the spawn point of the raid boss monster.

Further, the player can also engage in a match with the boss monster corresponding to the quest in the game field by moving to the vicinity of the point where the destination of the quest is set (e.g. within a 20-m radius). The destination (goal point) of each quest may be a player or a game operator.

In addition, the game according to the first embodiment allows for the use of game currencies. This game currency includes paid currencies and free currencies. The paid currencies are paid content that can be acquired by a purchase procedure (payment) using money, a prepaid card, a credit card, electronic money, a crypto asset, or the like. The paid currencies include, for example, a charging item (charged item), a charged coin (charged coin), a charging point (charged point), and the like. For example, in the game according to the first embodiment, billing items can be purchased for 100 yen. On the other hand, the free currencies are free content that can be acquired by game execution. The free currencies include, for example, a non-charging item (free item), a non-charged coin (free coin), a non-charging point (free point), and the like. Examples of the game execution include login of a game by a player, first clear of a quest, mission achievement, and the like. Free currencies can be consumed without distinction from paid currencies in various games.

### Functional Configuration

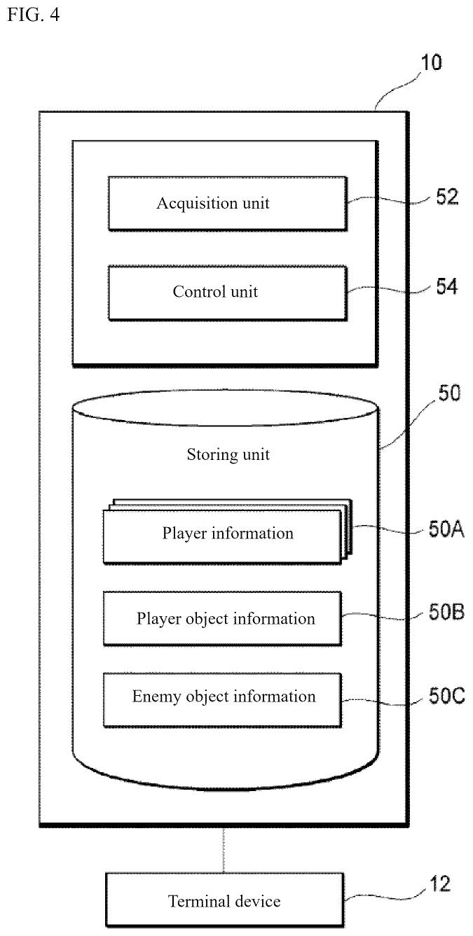

FIG. 4 is a block diagram illustrating an example of a functional configuration of the server device 10.

As illustrated in FIG. 4, the server device 10 includes a storage unit 50, an acquisition unit 52, and a control unit 54 as a functional configuration. The storage unit 50 is realized by one or a plurality of storage devices 28. The functional units other than the storage unit 50 is realized by the control device 20 executing the instructions stored in the storage device 28 or the like. All or a part of these functional configurations may be provided in the terminal device 12.

The storage unit 50 is a functional unit for storing the player information 50 A, the player object information 50 B, the enemy object information 50 C, and the like.

The player information 50 A is stored for each player in association with a player ID of the player. The player information 50 A includes, for example, the name of the player, the used character information, the owned item information, and the quest progress information.

The used character information includes ability information in association with the character ID of each of the player objects that the player can use. The ability information includes ability values and skill information. The ability values include, for example, levels, hit points, attack abilities, a defense abilities, and the like. The skill information includes a skill ID of a skill, which is a learned (available). Examples of skills include a method of recovering hit points, a special technique of attacking with a fire attribute, and the like.

The owned item information includes items ID and number of items (equipment items and consumable items) owned by the player.

The player object information 50 B is stored for each player object in association with the character ID of the player object. The player object information 50 B includes, for example, nomenclatures of player objects, images, required experience points for each level, ability information for each level, equippable items, and the like.

The required experience points includes the total experience points required to reach each level.

The ability information includes learned skills at each level, hit points, attack abilities, defense abilities, and the like.

The equippable items include item IDs of equipment items that can be equipped.

The enemy object information 50 C is stored for each enemy object in association with the object ID of the enemy object. This enemy objects include raid boss monsters. The enemy object information 50 C includes nomenclatures, images, appearance information, match allowable range, match information, ability information, reward information, and the like.

The appearance information includes a match allowable time and a match allowable range. This match allowable time is a time slot in which the player can engage in a match with the enemy object (raid boss monster). The match allowable time includes an appearance start date and time and an appearance time. The appearance start date and time includes the date and time when the enemy object starts to appear in the game field corresponding to the real world, and the appearance time. For example, the appearance start date and time of a certain raid boss monster is 5:00 PM every Monday. In addition, for example, the appearance time of a certain raid boss monster is 2 hours. In other words, the match allowable time of a certain raid boss monster is from 5 PM to 7 PM every Monday. This appearance time decreases from the timing at which the appearance start date is reached. This appearance time may be updated (increased or decreased) by the control unit 54. The match allowable range includes a range (region) for having matches with enemy objects in a game field corresponding to the real world. The match allowable range includes, for example, a spawn point of a raid boss monster represented by latitude and longitude in the real world, and a radius of a circular region with the spawn point as a center point. The initial value of this radius is, for example, 20 m. Note that the match allowable range may be indicated by a spawn point of a raid boss monster in the game field and a circular region having a spawn point as the center point.

The match information includes a match count in which a match game with an enemy object is executed, a date and time when each match game is executed, an enemy object (raid boss monster), and a player ID of a player who has executed the match game. Examples of the match count include the total count (cumulative count) of the number of times of the match game executed by the one or a plurality of players, and the number of times of the match game has been executed per unit time.

The ability information includes an ability value (level, hit points, attack abilities, defense abilities, and the like) and skill information. For example, the hit points of the raid boss monster decreases (approaches 0) each time the match game is executed by one or a plurality of players.

The reward information includes experience points, currency amounts, and drop item information. The drop item information includes an item ID and a drop rate of the drop item. The drop rate is a probability of granting a drop item to the player as a reward.

The acquisition unit 52 is a functional unit for acquiring the current position of each player. For example, the acquisition unit 52 acquires position information (latitude and longitude) in the real world received by the GPS reception unit 39 via the terminal device 12. The acquisition unit 52 may acquire the position (for example, coordinates on the game field) of the player object in the game field.

The control unit 54 is a functional unit for controlling the overall game. In the first embodiment, the control unit 54 executes a match game with an enemy object (a raid boss monster) that each player can commonly engage in a match during the match allowable time of the enemy object. Further, the control unit 54 executes a match game with the enemy object on the condition that the current position of the player has reached a match allowable range with the enemy object. For example, the control unit 54 references the appearance information in the enemy object information 50 C, and permits the execution of the match game with the enemy object when the position information of the player is included in the match allowable range of the appearance information during the match allowable time with the enemy object (for example, a raid boss monster). For example, when an instruction (match instruction) for executing a match game with the enemy object is performed by the player, the control unit 54 executes the match game.

Further, when the number of times of execution of the match game is less than a predetermined number of times at a predetermined time point, the control unit 54 expands the match allowable range. The predetermined time point is, for example, a time point when a unit time has elapsed. Examples of this unit time include, for example, 10 minutes, 30 minutes, 1 hour, and the like. The unit time may be a value obtained by dividing the appearance time of the enemy object by a predetermined number (for example, 2 or 5). For example, when the number of fights per unit time is less than a predetermined number of times each time the unit time elapses, the control unit 54 expands the match allowable range. Specifically, the control unit 54 references the match information of the enemy object information 50 C every time the unit time (for example, 30 minutes) has elapsed from the appearance start date and time of the raid boss monster, and acquires the matches count the raid boss monster per unit time. Subsequently, when the acquired match count is less than a predetermined number of times (for example, five times), the control unit 54 expands the match allowable range included in the appearance information of the raid boss monster by a predetermined area. Examples of this predetermined region include increasing the radius of a circle region centered on the spawn point of the raid boss monster by 50 m, increasing the radius by 100 m, and the like. Note that the predetermined number of times may gradually increase or gradually decrease each time the unit time elapses.

Further, the predetermined time point may be the time when the appearance time of the enemy object is less than a fixed time. Examples of this fixed time include, for example, 5 minutes, 10 minutes, 30 minutes, and the like. For example, when the appearance time of the raid boss monster is less than a fixed time, the control unit 54 references the match information of the enemy object information 50 C to acquire the match count (total count) with the raid boss monster. Subsequently, when the acquired match count is less than a predetermined number of times (for example, 15 times), the control unit 54 expands the match allowable range included in the appearance information of the raid boss monster by a predetermined area. Note that the fixed time may be a value obtained by dividing the appearance time of the enemy object by a predetermined number (for example, 2 or 5). The predetermined time point may be present a plurality of times at the appearance time of the enemy object.

Further, the control unit 54 extends the appearance time of the enemy object (raid boss monster) when the match allowable range is expanded. The control unit 54 extends the appearance time of the enemy object when the number of times a match game has been executed is less than a predetermined number of times at a predetermined time point. For example, when the number of times the match game is executed is less than the predetermined number of times, the control unit 54 extends the appearance time of the raid boss monster in the appearance information of the enemy object information 50 C by 30 minutes.

Further, each time the unit time elapses, the control unit 54 extends the appearance time of the enemy object when the number of times per unit time is less than the predetermined number of times. For example, the control unit 54 references the match information of the enemy object information 50 C every time the unit time (for example, 30 minutes) has elapsed from the appearance start date and time of the raid boss monster, and acquires the match count with the raid boss monster per unit time. Subsequently, when the acquired match count is less than a predetermined number of times (for example, five times), the control unit 54 extends the appearance time of the raid boss monster in the appearance information by 10 minutes.

### Flow of Match Process

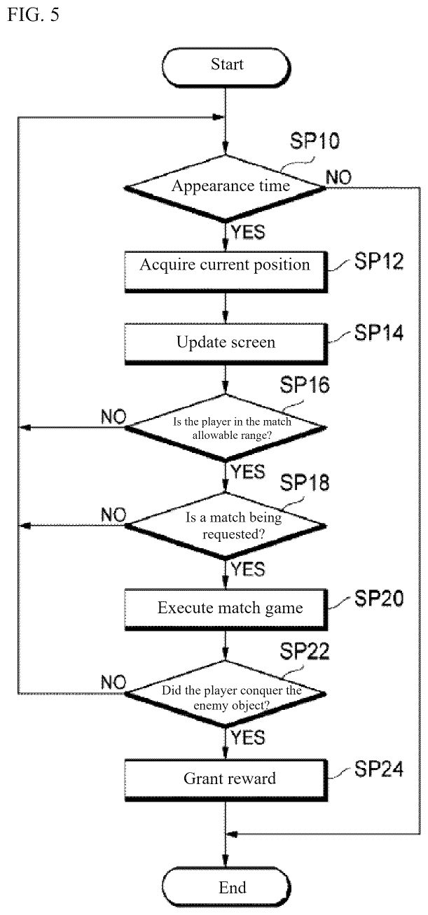

FIG. 5 is a flowchart illustrating an example of a flow of a process in which a player engages in a match game with a raid boss monster in the game system 1 according to the first embodiment. Further, the processing of the following steps is started, for example, at a timing when an appearance start date of a certain raid boss monster is reached. Note that the order and the content of the following steps can be changed as appropriate.

### Step SP 10

The control unit 54 references the appearance information of the enemy object information 50 C to determine whether the appearance time of a certain raid boss monster is greater than 0 (0 seconds). When the determination result is affirmative, the process proceeds to the process of step SP 12. On the other hand, when the determination result is negative, the processing ends the series of processes illustrated in FIG. 5.

### Step SP 12

The acquisition unit 52 acquires the current position (latitude and longitude) of the player. Subsequently, the process proceeds to the processing of step SP 14.

### Step SP 14

The control unit 54 updates the game screen displayed on the touch panel 32 based on the current position of the player acquired in step SP 12. That is, the control unit 54 moves the player object to a position (coordinates) on the game field corresponding to the current position of the player.

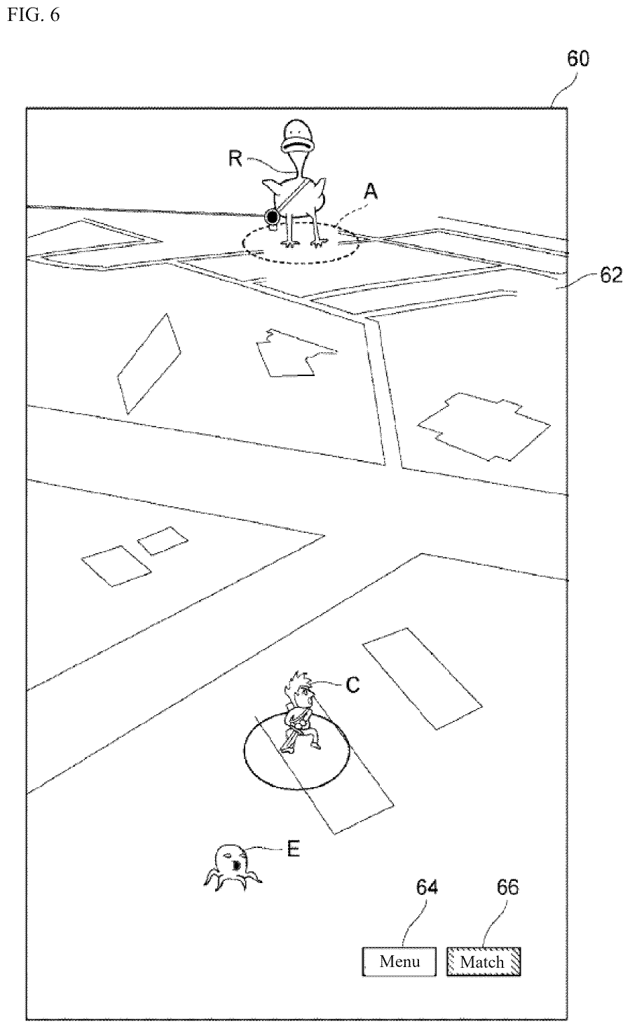

FIG. 6 is a diagram illustrating an example of the game screen 60 according to the first embodiment.

As shown in FIG. 6, the game screen 60 is provided with a game field 62, a menu button 64, and a match button 66.

The game field 62 is represented, for example, in a scenery around the current position of the player in the real world. The game field 62 includes a player object P, a normal monster E, and a raid boss monster R. The player object P is displayed based on the player object information 50 B of the player. The normal monster E and the raid boss monster R are displayed based on the enemy object information 50 C. In the game field 62, a match allowable range A is set using the appearance point of the raid boss monster R as the center. For example, when the player object P reaches the inside of the match allowable range A, the player can execute a match game with the Raid boss monster R.

The menu button 64 is a button for performing an instruction to display the equipping (attachment/detachment) of equipment items and various menus for using consumption items.

The match button 66 is a button for instructing the execution of the match game with the raid boss monster R. This match button 66 can be pressed when the player object P reaches the inside of the match allowable range A.

Returning to FIG. 5, the process proceeds to the process of step SP 16.

### Step SP 16

The control unit 54 determines whether the current position of the player acquired in step SP 12 is included in a match allowable range of a certain raid boss monster. When the determination result is affirmative, the process proceeds to the process of step SP 18. On the other hand, when the determination result is negative, the process proceeds to the process of step SP 10.

### Step SP 18

The control unit 54 permits the execution of a match game with a certain raid boss monster. Specifically, the control unit 54 can press the match button. Subsequently, the control unit 54 determines whether the execution of the match game from the player is requested. For example, the control unit 54 determines whether the match button has been pressed by the player. When the determination result is affirmative, the process proceeds to the process of step SP 20. On the other hand, when the determination result is negative, the process proceeds to the process of step SP 10.

### Step SP 20

The control unit 54 executes a match game between the player object associated with the player and a certain raid boss monster. Subsequently, the control unit 54 updates the various types of information of the enemy object information 50 C corresponding to a certain raid boss monster based on the match game. For example, the control unit 54 incrementally increases (+1) the match count included in the match information of a certain raid boss monster. In addition, the control unit 54 reduces the hit points included in the ability information of a certain raid boss monster. Subsequently, the process proceeds to the process of step SP 22.

### Step SP 22

The control unit 54 determines whether a certain raid boss monster has been conquered. For example, the control unit 54 determines whether the hit points of a certain raid boss monster has become equal to or less than 0. When the determination result is affirmative, the process proceeds to the process of step SP 24. On the other hand, when the determination result is negative, the process proceeds to the process of step SP 10.

### Step SP 24

The control unit 54 references the match information of the enemy object information 50 C and grants a reward to each player who has executed a match game with a certain raid boss monster. Subsequently, the process ends the series of processes illustrated in FIG. 5.

### Flow of Expanding/Extending Process

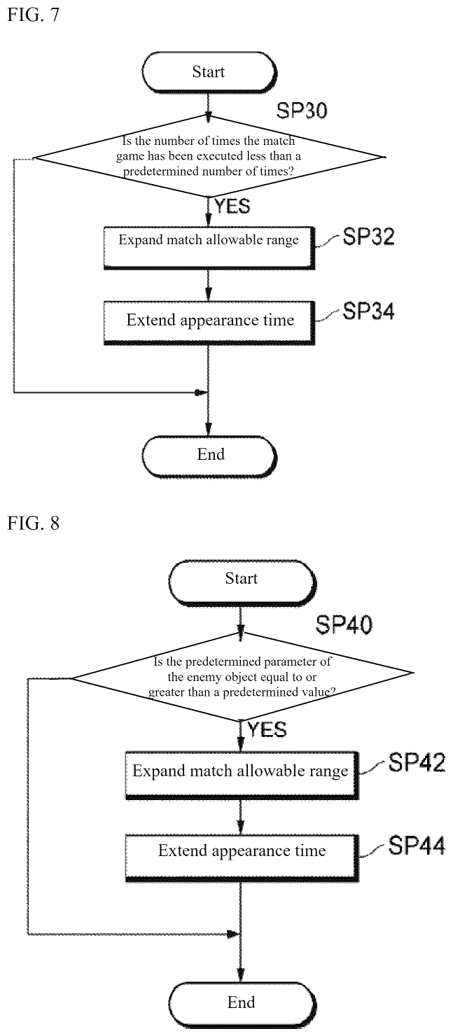

FIG. 7 is a flowchart illustrating an example of a flow of processing for extending the match allowable range and extending the appearance time in the game system 1 according to the first embodiment. Further, the processing of the following steps is started, for example, at a predetermined time point (e.g. a point of time when the unit time has elapsed) within the match allowable time of a certain raid boss monster. Note that the order and the content of the following steps can be changed as appropriate.

### Step SP 30

The control unit 54 references the match information of the enemy object information 50 C to determine whether the match count with a certain raid boss monster is less than a predetermined number of times (for example, 5 times). Subsequently, when the determination result is affirmative, the process proceeds to the process of step SP 32. On the other hand, when the determination result is negative, the processing ends the series of processes illustrated in FIG. 7.

### Step SP 32

The control unit 54 expands the match allowable range of a certain raid boss monster by a predetermined area. For example, the control unit 54 increases the radius of the circle region in the match allowable range of the enemy object information 50 C by 100 m. Subsequently, the process proceeds to the process of step SP 34.

### Step SP 34

The control unit 54 extends the appearance time of a certain raid boss monster. For example, the control unit 54 extends (increases) the appearance time of the raid boss monster in the appearance information of the enemy object information 50 C by 30 minutes. Subsequently, the process ends the series of processes shown in FIG. 7.

### Technical Effect

Thus, in the first embodiment, the instructions stored in the non-transitory computer readable recording medium execute a match game with an enemy object in which each player can commonly play is executed during an appearance time of the enemy object, and cause the computer to function as the acquisition unit 52 for acquiring the current position of each of the players in the real word, and the control unit 54 for executing the match game with the enemy object on condition that the current position has reached a match allowable range with the enemy object. The control unit 54 expands the match allowable range upon determining that the number of times of execution of the match game is less than a predetermined number of times at a predetermined point of time.

According to this configuration, by expanding the match allowable range when the number of times the match game has been executed with the enemy object is small, the enemy object can be easily conquered, which provides the functionality to level the playing field for players who play in the area with the small number.

Further, in the first embodiment, the predetermined time point is a time point at which a unit time has elapsed, and the control unit 54 expands the match allowable range upon determining that the number of times per the unit time is less than the predetermined number of times each time the unit time elapses.

According to this configuration, since the match allowable range is expanded every time the unit time elapses, the enemy object can be easily conquered, thereby providing the functionality to level the playing field for players who play in the area with the small number.

Further, in the first embodiment, the predetermined time point is the time at which the appearance time becomes less than a fixed time.

According to this configuration, since the match allowable range can be expanded when the appearance time of the enemy object becomes less than a fixed time, the enemy object can be easily conquered, which provides the functionality to level the playing field for players who play in the area with the small number.

Further, in the first embodiment, the control unit 54 extends the appearance time when the match allowable range is expanded.

According to this configuration, since the match allowable range is expanded and the appearance time of the enemy object is extended, the enemy object can be conquered, which provides the functionality to level the playing field for players who play in the area with the small number.

Further, in the first embodiment, the instructions stored in the non-transitory computer readable recording medium execute a match game with an enemy object in which each player can commonly play during an appearance time of the enemy object, and cause the computer to function as the acquisition means 52 for acquiring the current position of each of the players, and function as the control means 54 for executing the match game with the enemy object on condition that the current position has reached a match allowable range with the enemy object, and the control means 54 extends the appearance time upon determining that the number of times of execution of the match game has been executed is less than a predetermined number of times at a predetermined time point.

According to this configuration, since the appearance time of the enemy object is extended when the number of times the match game has been executed is small, the enemy object can be easily conquered, thereby providing the functionality to level the playing field for players who play in the area with the small number.

Further, in the first embodiment, the predetermined time point is a time point at which a unit time has elapsed, and the appearance time is expanded upon determining that the number of times per the unit time is less than the predetermined number of times each time the unit time elapses.

According to this configuration, since the appearance time of the enemy object can be extended every time the unit time elapses, the enemy object can be easily conquered, thereby providing the functionality to level the playing field for players who play in the area with the small number.

Further, in the first embodiment, the predetermined time point is the time point at which the appearance time becomes less than a fixed time.

According to this configuration, since the appearance time can be extended when the appearance time of the enemy object becomes less than a fixed time, the enemy object can be easily conquered, thereby providing the functionality to level the playing field for players who play in the area with the small number.

### Second Embodiment

Next, a second embodiment will be described.

In the second embodiment, the control unit 54 is different from the first embodiment in that the control unit 54 expands the match allowable range according to the predetermined parameter of the enemy object or extends the appearance time of the enemy object. The configuration and function of the game system 1 according to the second embodiment not described below are the same as the configuration and function of the game system 1 according to the first embodiment.

When the predetermined parameter of the enemy object is equal to or greater than a predetermined value at a predetermined time point, the control unit 54 expands the match allowable range. This predetermined parameter is, for example, a parameter indicating that the match game has progressing (being conquered) when the value is small. In other words, the predetermined parameter is a parameter indicating that the enemy object is close to be successfully conquered when the value is small. In the second embodiment, the predetermined parameter is the hit points (vitality) of the enemy object. For example, each time the unit time elapses, the control unit 54 expands the match allowable range when the hit points of the enemy object is equal to or greater than a predetermined value. Specifically, the control unit 54 references the ability information of the enemy object information 50 C every time the unit time (for example, 50 minutes) has elapsed from the appearance start date and time of the raid boss monster, and acquires the hit point of the raid boss monster. Subsequently, when the acquired hit points are equal to or greater than a predetermined value (for example, 10,000), the control unit 54 expands the match allowable range included in the appearance information of the raid boss monster by a predetermined area. Examples of this predetermined region include increasing 50 m of the radius of a circle region centered on the spawn point of the raid boss monster, increasing the radius by 100 m, and the like. Note that the predetermined parameter may gradually increase or gradually decrease each time the unit time elapses.

Further, the control unit 54 extends the appearance time of the enemy object (raid boss monster) when the match allowable range is expanded. Further, the control unit 54 extends the appearance time of the enemy object when the predetermined parameter of the enemy object is equal to or greater than a predetermined value at a predetermined time point. Further, each time the unit time elapses, the control unit 54 extends the appearance time of the enemy object when the predetermined parameter of the enemy object is equal to or greater than a predetermined value. For example, when the predetermined parameter of the enemy object is equal to or greater than a predetermined value, the control unit 54 extends the appearance time of the raid boss monster in the appearance information of the enemy object information 50 C by 30 minutes.

### Expansion/Extension Process

FIG. 8 is a flowchart illustrating an example of a flow of processing for extending the match allowable range and extending the appearance time in the game system 1 according to the second embodiment. Further, the processing of the following steps is started, for example, at a predetermined time point within the match allowable time of a certain raid boss monster (e.g. a point in time when the appearance time of a certain raid boss monster becomes less than a fixed time). Note that the order and the content of the following steps can be changed as appropriate. (Step SP 40)

The control unit 54 references the ability information of the enemy object information 50 C to determine whether the hit points of the certain raid boss monster are equal to or greater than a predetermined value (e.g. 10,000). When the determination result is affirmative, the process proceeds to the process of step SP 42. On the other hand, when the determination result is negative, the processing ends the series of processes illustrated in FIG. 8.

### Steps SP 42 to SP 44

Since the processes in steps SP 42 to SP 44 are the same as those in the steps SP 32 to SP 34 described above, the descriptions thereof will be omitted. Subsequently, the process ends the series of processes shown in FIG. 7.

### Technical Effect

In the second embodiment, the instructions stored in the non-transitory computer readable recording medium execute the match game with the enemy object in which each player can commonly play is executed at an appearance time of the enemy object, and cause a computer to function as the acquisition unit 52 for acquiring the current position of each of the players in the real world, and the control unit 54 for executing the match game with the enemy object on condition that the current position has reached a match allowable range with the enemy object. The control unit 54 expands the match allowable range upon determining that the number of times of execution of the match game is less than a predetermined number of times at a predetermined time point.

According to this configuration, in order to expand the match allowable range when the predetermined parameter of the enemy object is large, the enemy object can be easily conquered, which provides the functionality to level the playing field for players who play in the area with the small number.

Further, in the second embodiment, the predetermined time point is a time point at which a unit time has elapsed, and the control unit 54 expands the match allowable range if the predetermined parameter of the enemy object is equal to or greater than a predetermined value every time the unit time elapses.

According to this configuration, since the match allowable range is expanded every time the unit time elapses, the enemy object can be easily conquered, which provides the functionality to level the playing field for players who play in the area with the small number.

Further, in the second embodiment, the predetermined time point is a time point at which the appearance time becomes less than a fixed time.

According to this configuration, since the match allowable range can be expanded when the appearance time of the enemy object becomes less than a fixed time, the enemy object can be easily conquered, which provides the functionality to level the playing field for players who play in the area with the small number.

In the second embodiment, the control unit 54 extends the appearance time of the enemy object when expanding the match allowable range.

According to this configuration, since the match allowable range is expanded and the appearance time of the enemy object is extended, the enemy object can be easily conquered, which provides the functionality to level the playing field for players who play in the area with the small number.

In addition, in the second embodiment, the instructions stored in the non-transitory computer readable recording medium execute a match game with an enemy object that each player can commonly play in is executed in the appearance time of the enemy object, and cause the computer to function as the acquisition unit 52 that acquires the current position of each of the players in the real world, and the control unit 54 that executes a match game with the enemy object on the condition that the current position of the player has reached a match allowable range with the enemy object, in which the control unit 54 extends the appearance time of the enemy object upon determining that the predetermined parameter of the enemy object is equal to or greater than a predetermined value at a predetermined time point.

According to this configuration, since the appearance time of the enemy object is extended when the predetermined parameter of the enemy object is large, the enemy object can be easily conquered, which provides the functionality to level the playing field for players who play in the area with the small number.

Further, in the second embodiment, the predetermined time point is a time point at which a unit time has elapsed, and the control unit 54 extends the appearance time upon determining that the predetermined parameter of the enemy object is equal to or greater than a predetermined value every time the unit time elapses.

According to this configuration, since the appearance time of the enemy object can be extended every time the unit time elapses, the enemy object can be easily conquered, which provides the functionality to level the playing field for players who play in the area with the small number.

Further, in the second embodiment, the predetermined time point is a time point at which the appearance time becomes less than a fixed time.

According to this configuration, since the appearance time can be extended when the appearance time of the enemy object becomes less than a fixed time, the enemy object can be easily conquered, which provides the functionality to level the playing field for players who play in the area with the small number.

### Modifications

Note that the present invention is not limited to the above-described embodiments. That is, a person skilled in the art, as appropriate, adds design change to the above-described embodiments, as long as the features of the present invention are included and the changes fall within the scope of the present invention. Further, each element of the above-described embodiments and the modifications described below can be combined as much as possible, and a combination of these elements is also included in the scope of the present invention as long as it includes the features of the present invention.

For example, although the first embodiment described a case in which the control unit 54 expands the match allowable range of the raid boss monster or extends the appearance time whenever the number of times the match game is executed is less than a predetermined number of times at a predetermined point of time, the predetermined number of times may be changed for each raid boss monster. For example, the predetermined number of times may be increased or reduced in accordance with at least one of the ability value (level, hit points, attack ability, defense ability, and the like) of the raid boss monster.

Further, although the second embodiment described a case in which the control unit 54 increased the match allowable range of the raid boss monster or extended the appearance time whenever the predetermined parameter of the enemy object is equal to or greater than a predetermined value at a predetermined point of time, this predetermined parameter may be changed for each raid boss monster. For example, the predetermined value may be increased or reduced in accordance with at least one of the ability value (level, hit points, attack ability, defense ability, and the like) of the raid boss monster.

In addition, in the second embodiment, the control unit 54 may expand the match allowable range of the raid boss monster or extend the appearance time of the raid boss monster when the amount of reduction of the predetermined parameter of the raid boss monster per unit time is less than a predetermined value. For example, the control unit 54 may expand the match allowable range of the raid boss monster or extend the appearance time when the amount of hit points of the raid boss monster is reduced every 10 minutes is less than 1000.

Further, although the second embodiment described a case in which the predetermined parameter is hit points, it may instead be an energy amount, a defensive ability, or the like.

In addition, when the value is large, the predetermined parameter may be a parameter indicating that the match game is progressing. For example, the predetermined parameter may be the number of weak points of the enemy object discovered by each player. In this case, when the predetermined parameter (the number of weak points found) of the enemy object is less than the predetermined value at a predetermined time point, the control unit 54 expands the match allowable range.

Further, although the first embodiment and the second embodiment describe cases where the enemy object is a monster, it may instead be a character, a robot, a vehicle, an airplane, a ship, or the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### Description of the Numerals

10 server device (computer, information processing device), 12 terminal device (computer, information processing device), 50 storage unit, 52 acquisition unit, 54 control unit

What is claimed is:

1. A non-transitory computer readable recording medium storing instructions that execute gaming based on position information of players in a real world, the instructions causing a computer to execute:
acquiring a current position of each of the players in the real world; and
executing a match game with an enemy object in an appearance time of the enemy object in which any of the players can commonly match the enemy object, on condition that the current position has reached a match allowable range with the enemy object, wherein
the executing the match game includes:
expanding the match allowable range upon determining that a number of times of execution of the match game is less than a predetermined number of times at a predetermined time point.

2. The non-transitory computer readable recording medium according to claim 1, wherein
the predetermined time point is a time point at which a unit time has elapsed, and the executing the match game includes:
expanding the match allowable range upon determining that the number of times per the unit time is less than the predetermined number of times each time the unit time elapses.

3. The non-transitory computer readable recording medium according to claim 1, wherein
the predetermined time point is a time point at which the appearance time becomes less than a fixed time.

4. The non-transitory computer readable recording medium according to claim 1, wherein
the executing the match game includes:
extending the appearance time when expanding the match allowable range.

5. A non-transitory computer readable recording medium storing instructions that execute gaming based on position information of players in a real world, the instructions causing a computer to execute:
acquiring a current position of each of the players; and
executing a match game with an enemy object in an appearance time of the enemy object in which any of the players can commonly match the enemy object, on condition that the current position has reached a match allowable range with the enemy object, wherein
the executing the match game includes:
extending the appearance time upon determining that a number of times of execution of the match game is less than a predetermined number of times at a predetermined time point.

6. The non-transitory computer readable recording medium according to claim 5, wherein
the predetermined time point is a time point at which a unit time has elapsed, and
the executing the match game includes:
extending the appearance time upon determining that a number of times per the unit time is less than the predetermined number of times each time the unit time elapses.

7. The non-transitory computer readable recording medium according to claim 5, wherein
the predetermined time point is a time point at which the appearance time becomes less than a fixed time.

8. An information processing device that executes gaming based on position information of players in a real world, the information processing device comprising:
a controller that:
acquires a current position of each of the players in the real world, and
executes a match game with an enemy object in an appearance time of the enemy object in which any of the players can commonly match the enemy object, on condition that the current position has reached a match allowable range with the enemy object, wherein
the controller expands the match allowable range upon determining that a number of times of execution of the match game is less than a predetermined number of times at a predetermined time point.

9. An information processing device that executes gaming based on position information of players in a real world, the information processing device comprising:
a controller that:
acquires a current position of each of the players in the real world, and
executes a match game with an enemy object in an appearance time of the enemy object in which any of the players can commonly match the enemy object, on condition that the current position has reached a match allowable range with the enemy object, wherein
the controller extends the appearance time upon determining that a number of times of execution of the match game is less than a predetermined number of times at a predetermined time point.
